(19) United States
(12) Patent Application Publication
(10) Pub. No.: US 2016/0347283 A1
(43) Pub. Date: Dec. 1, 2016

(54) END JOINING PIECE DESIGNED TO BE FITTED ON A FLEXIBLE SUPPORT, AND WIPER COMPRISING THE END JOINING PIECE AND THE FLEXIBLE SUPPORT

(71) Applicant: Valeo Systèmes d'Essuyage, Le Mesnil Saint Denis (FR)

(72) Inventors: Olivier Jomard, Aubiere (FR); Stéphane Houssat, Blanzat (FR); Vincent Gaucher, Ennezat (FR); Eric Poton, Pont Du Chateau (FR)

(73) Assignee: Valeo Systèmes d'Essuyage, Le Mesnil Saint Denis (FR)

(21) Appl. No.: 15/166,309

(22) Filed: May 27, 2016

(30) Foreign Application Priority Data
Jun. 1, 2015 (FR) 1554943

(51) Int. Cl. B60S 1/04

(52) U.S. Cl. CPC B60S 1/043

(57) ABSTRACT

The invention relates to an end joining piece (1) for a wiper of a window of a vehicle, comprising at least one flexible support (3) as well as a friction blade (4) which is designed to be applied against the window. The end joining place (1) comprises a receptacle (5) which can receive an end part (28) of the flexible support (3). The end joining piece (1) is provided with at least one means (7) for locking the end part (28) of the flexible support (3) in the engaged position inside the receptacle (5). The locking means (7) comprise an orifice (10) which equips the end joining piece (1) and a stud (8) which is equipped with a finger (9).

The field of the present invention is that of wipers which are designed to equip a motor vehicle. The invention concerns more particularly an end joining piece which is designed to ho fitted on a flexible support, the end joining piece and the flexible support constituting a wiper. The invention also concerns the said wiper and a wiper system which incorporates a wiper of this type. The invention also relates to a method for assembly of the end joining piece on the flexible support.

A motor vehicle is commonly equipped with a wiper system in order to ensure wiping and washing of a component windscreen of the motor vehicle, so as to prevent the view which a driver of the motor vehicle has of his environment from being disrupted. The wiper system is conventionally driven by an arm which performs an angular to-and-fro movement opposite the windscreen and within a field of vision of the driver. The wiper system comprises at least one elongate wiper, which itself supports a friction blade made of a flexible material. The friction blade scrapes against the windscreen and discharges the water, taking it outside the field of vision of the driver. The wiper is produced either, in a conventional version, in the form of an articulated swing bar which holds the friction blade in a plurality of discrete locations, or, in a more recent version which is commonly known as a flat blade. In the form of a semi-rigid assembly which retains the scraper blade along its entire length. In this second solution, the semi-rigid assembly is attached to an arm which the wiper system comprises by means of an assembly constituted by a mechanical connector and an adapter. The mechanical connector is a part which is crimped directly on the wiper, whereas the adapter is an intermediate part which permits the securing of the connector on the arm of the wiper system.

Document WO 2013/000630 proposes a wiper system of the second type, the semi-rigid assembly of which comprises a flexible support and an end joining piece which are rendered integral by means of locking means which the end joining piece comprises.

The locking means are found to he unsatisfactory in particular in stringent but common conditions of use to which the wiper is liable to be subjected.

Firstly, it is found that the locking means can be activated in an untimely manner. In particular by a user or a malicious passer-by, which in certain situations leads to uncoupling of the end joining piece from the wiper.

Secondly, a mechanical connection between the locking means and the support of the wiper is not sufficiently secure. It is necessary to increase a level of security and/or reliability of this mechanical connection.

Finally, the wiper is liable to undergo mechanical stresses, which can give rise to deterioration or even dislocation of the wiper, starting with separation of the end joining piece and the flexible support, dismantling of this type of the wiper giving rise for example to a loss of the air deflector(s) which equip(s) the wiper, and ultimately to destruction of the latter.

The objective of the present invention is to eliminate the above-described disadvantages by proposing a robust end joining piece which is designed to withstand stringent conditions of use, and in particular untimely activation of the end joining piece, the latter additionally being easy to produce. The end joining piece thus designed increases a level of security and/or reliability of the securing of the locking means relative to the flexible support which constitutes a wiper according to the present invention, which can withstand an effort causing deterioration by a user or a malicious passer-by.

A joining piece according to the present invention is an end joining piece for a wiper of a window of a motor vehicle, comprising at least one flexible support as well as a friction blade which is designed to be applied against the window. The end joining piece comprises a receptacle which can receive an end part of the flexible support. The end joining piece is provided with at least one means for locking the end part of the flexible support in the engaged position inside the receptacle.

According to the present invention, the lacking means comprise at least one orifice which equips the end joining piece, and at least one stud which is equipped with at least one finger. There can be a plurality of orifices and fingers. It is also possible for the locking means to comprise only a single orifice and a single stud, the stud being provided with a plurality of fingers.

The finger is advantageously accommodated, and preferably fitted, inside the orifice in the position of use of the wiper.

The finger is tubular and has a circular cross-section. Alternatively, the cross-section can be rectangular or square. The orifice advantageously has a complementary form, i.e. a circular or rectangular or square cross-section.

The orifice is preferably arranged inside a base wall which delimits a cavity for receipt of the stud.

The orifice is in communication with the cavity, this orifice opening into the cavity.

The cavity is advantageously in communication with the receptacle for receipt of the end part of the flexible support.

In particular, the stud comprises a central pin which is bordered by two lateral pins provided on both sides of the central pin.

The central pin has for example a first thickness which is greater than a second thickness of at least one of the lateral pins.

The central pin preferably comprises an inner recess.

The finger is preferably arranged plumb with the central pin.

The stud advantageously comprises a first face for fitting of the stud on the end joining piece, the first fitting face being provided with the finger.

The first filling face advantageously extends according to a first fitting plane which is orthogonal to a first direction of extension of the finger.

The finger advantageously comprises means for rendering the stud integral on the end joining piece.

The means for rendering integral preferably comprise a terminal end of the finger which is equipped with a bulge provided with at least one notch. This bulge end this notch permit the insertion of the finger in the orifice, end prevent the extraction of the finger.

Alternatively, the means for rendering integral can be formed by a tongue which is articulated on a body of the finger, and is provided at the free end of the finger, when the latter has a square or rectangular cross-section. An articulated tongue of this type permits insertion of the linger in the orifice, and prevents the extraction of the finger by engagement of the tongue on the base wall.

A wiper according to the present invention comprises at least one such end joining piece end the said flexible support inserted inside the receptacle.

The stud comprises a first face for anchoring of the stud inside an indentation in the flexible support, the first anchoring face extending according to a first anchoring plane which is parallel to a first fitting plane. The latter is advantageously identical to the first fitting plane previously referred to in the description.

According to a first variant embodiment, the first fitting plane and the first anchoring plane are combined.

According to a second variant embodiment the first fitting plane and the first anchoring plane are distinct.

A wiper system according to the present invention comprises a wiper of this type and an arm to drive the said wiper.

A method for assembly of a wiper of this type is characterised in that the assembly method comprises a first step of insertion of the end part of the flexible support in the position engaged inside the receptacle of the end joining piece.

The assembly method comprises in particular a second step of introduction of the stud inside the cavity, of the finger inside the orifice, and of the second anchoring face inside an indentation in the flexible support. The indentation is advantageously identical to the indentation previously referred to in the description.

These arrangements are such that the means for locking the flexible support and the end joining piece advantageously cannot be taken to pieces, in the sense that the association of the end joining piece and the flexible support is robust and permanent for stringent but common conditions of use of the wiper, and an association of this type of the end joining piece and the flexible support can be broken only by means of destruction of the end joining piece and/or the flexible support.

Other characteristics, details and advantages of the invention will become more apparent from reading the description provided hereinafter by way of indication in relation with drawings in which:

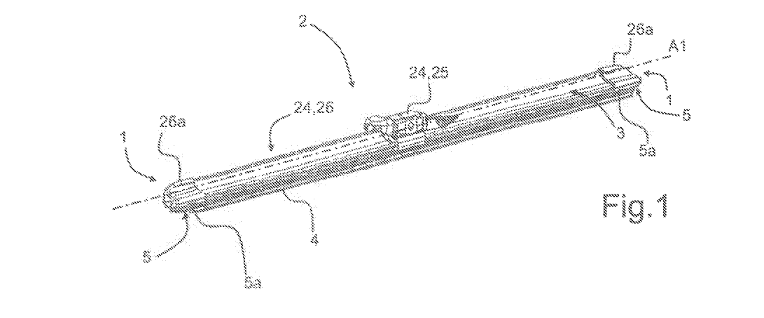

FIG. 1 is a general view in perspective of a wiper according to the present invention, which is designed to be fitted on a windscreen of a motor vehicle;

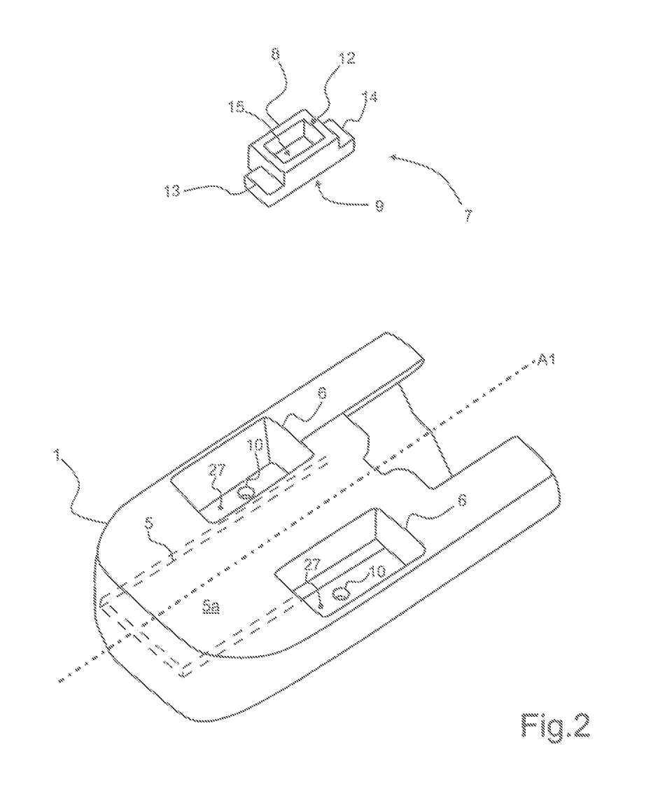

FIG. 2 is a view in perspective of an end joining piece which is a component of the wiper illustrated for example in FIG. 1, the said view being taken during a step before a phase of assembly of the end joining piece on a flexible support;

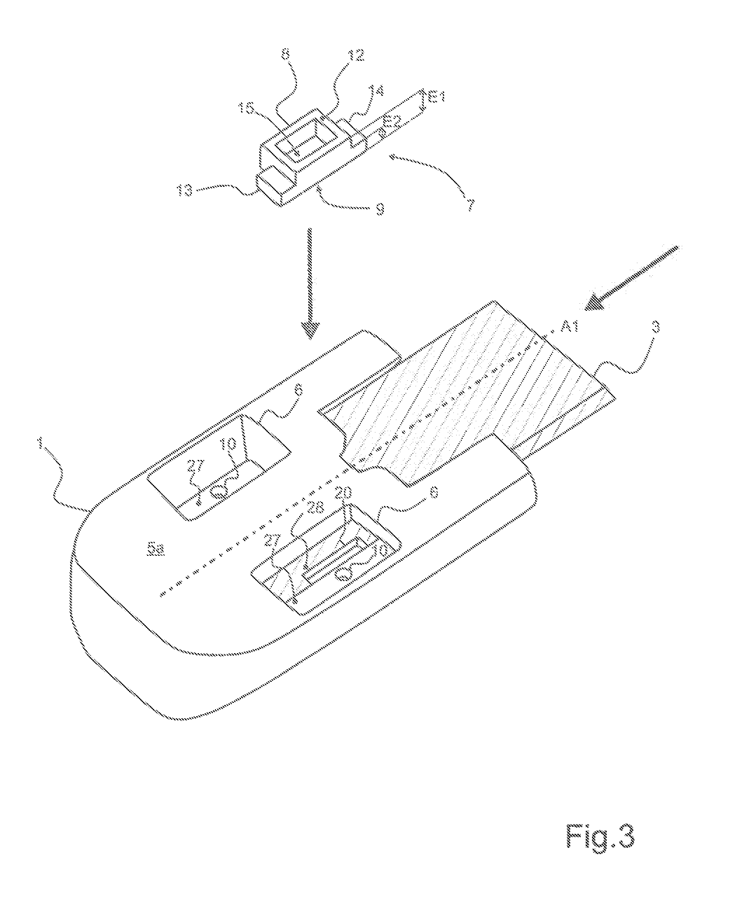

FIG. 3 is a view in perspective of the end joining piece illustrated in FIG. 2, and a partial view of the flexible support, the said view being taken during a first step of the phase of assembly of the end joining piece on the flexible support, with the first step succeeding the preliminary step;

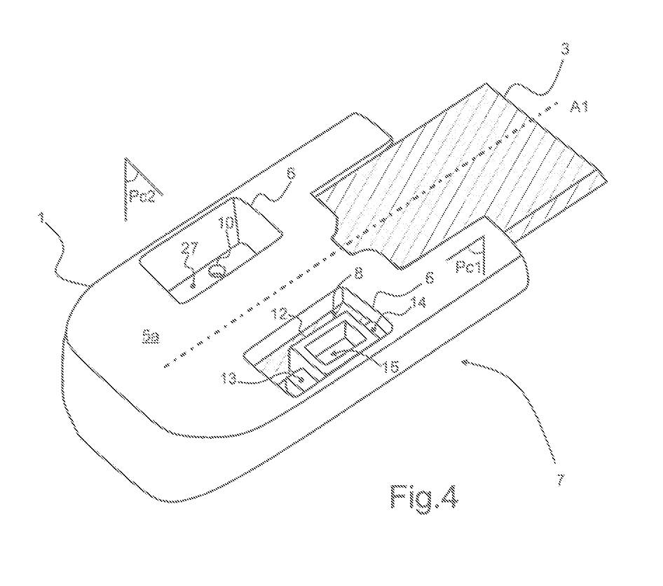

FIG. 4 is a partial view in perspective of the end joining piece and the flexible support illustrated in FIG. 3, the said view being taken during a second step of the phase of assembly of the end joining piece on the flexible support, with the second step succeeding the first step;

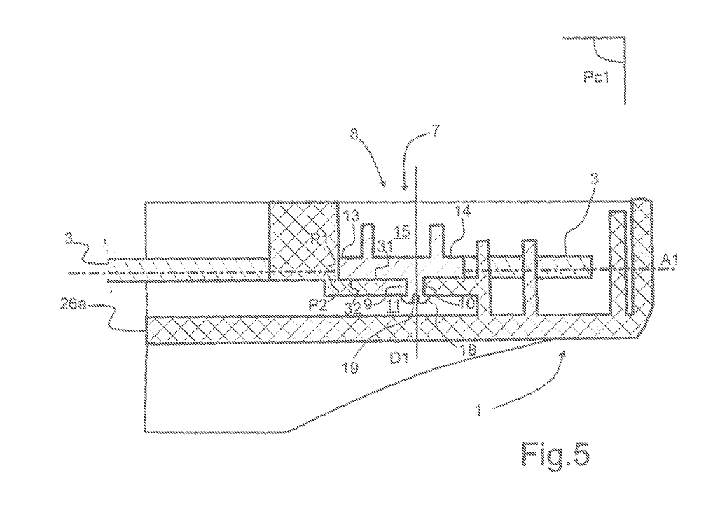

FIG. 5 is a partial view in cross-section of the end joining piece and the flexible support illustrated in FIG. 4, the said view in cross-section being taken according to a first cross-sectional plane which is parallel to a longitudinal axis of extension of the wiper, and passing via the finger;

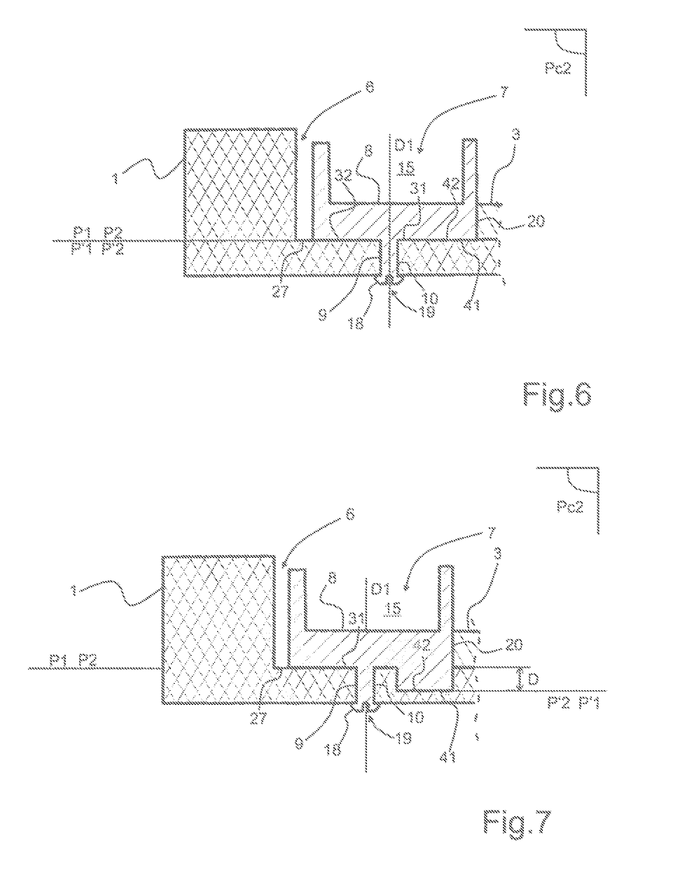

FIG. 6 is a partial view in cross-section of a first variant embodiment of the end joining piece and of the flexible support illustrated in FIG. 5, the said view in cross-section being taken according to a second cross-sectional plane which is orthogonal to the first cross-sectional plane, and which passes via the finger;

FIG. 7 is a partial view in cross-section of a second variant embodiment of the end joining piece and the flexible support illustrated in FIG. 5, the said view in cross-section also being taken according to the second cross-sectional plane.

It should be noted firstly that the figures show the present invention in detail for implementation of the invention, and it will be appreciated that the said figures can be used to define the invention better if applicable.

In the figures, the term longitudinal refers to the orientation of an end joining piece 1 or of a wiper 2 according to the invention. The longitudinal direction corresponds to a longitudinal axis A1 of general extension of the wiper 2, whereas a transverse orientation corresponds to a converging direction, i.e. which intersects the longitudinal direction, and is in particular perpendicular to the longitudinal axis A1 of general extension of the wiper 2.

In FIG. 1, the wiper 2 according to the present invention is represented in perspective. A wiper 2 of this type is used to scrape a window of a motor vehicle. Preferably, the window is a windscreen which equips a passenger space of the motor vehicle. Alternatively, the window is a rear window of the motor vehicle. In these cases, the wiper 2 serves the purpose of displacing water and/or dirt deposited on the windscreen out of the field of vision of a driver. According to another example, the glass is for example the glass of a headlight which equips the motor vehicle. In this case, the wiper 2 serves the purpose of displacing water and/or did deposited on the glass out of a lighting field.

The wiper 2 is constituted by at least one flexible support 3, a component 24, a friction blade 4, and at least one end joining piece 1, or even, and preferably, two end joining pieces 1 installed on each end area of the flexible support 3.

The flexible support 3 can take the form of a single flexible flat metal strip. According to an alternative, the flexible support 3 can be formed by two flexible metal strips each accommodated in a notch provided on both sides of the friction blade 4. In the two above cases, in the state of rest, a metal strip of this type is curved according to a plane perpendicular to a longitudinal direction of the metal strip. The purpose of a metal strip of this type, whether it is single or double, is to distribute the support forces along the friction blade 4 which are generated by a connection means 25 attached to the flexible support 3 in the centre, longitudinally, of the wiper 2.

The component 24 designates a plurality of types of part which constitute the wiper 2. it can concern the connection means 25 which are designed to connect the wiper 2 to an arm which drives the wiper 2 in rotation. It can also concern one or a plurality of air deflectors 26 which are added onto the flexible support 3, and the purpose of which is to transform a How of air which passes onto the wiper 2 into a support force which places the friction blade 4 against the glass.

The end joining piece 1 comprises an upper wall 26a which extends the air deflector 26. The upper wall 26a is a wall which can he seen from a point of observation of the motor vehicle situated at the front of the latter. However, the upper wall 26a delimits a receptacle 5 which can be seen below the wiper 2, Wore particularly, the receptacle 5 is provided through a lower wall 5a, which, in the position of use of the wiper 2, is arranged opposite the windscreen of the motor vehicle. The receptacle 5, which is represented in a broken line in FIG. 2, is designed to receive an end part 28 of the flexible support 3, as illustrated in FIG. 3.

In FIGS. 2 to 7, the end joining piece 1 comprises at least one means 7 for locking the end joining piece 1 on the flexible support 3. The locking means 7 advantageously cannot be taken to pieces, in the sense that the locking means 7 are robust for stringent but common conditions of use of the wiper 2. More particularly, the locking means 7 provide a robust mechanical connection between the end joining piece 1 and the flexible support 3, which connection is in particular resistant to a malicious action by a user who wishes to dismantle the wiper 2, and in particular the air deflector 28. In other words, it will be understood from the fact that the mechanical connection between the end joining piece 1 and the flexible support 3 cannot be taken to pieces that separation of these two elements necessarily involves destruction of at least one, or even both of the two elements.

Advantageously, the locking means 7 comprise at least one stud 3 provided with at least one finger 9 which is designed to be fitted inside a corresponding orifice 10 which the end joining piece 1 comprises. More particularly, the orifice 10 is arranged inside a base wall 27 which partly delimits a cavity 6 designed to receive the stud 8. In the position of use of the wiper, the base wall 27 faces the window of the motor vehicle. The cavity 6 is advantageously provided inside the lower wall 5a in order to be protected against rain and/or projections of dirt.

The finger 9 forms a tube with a circular cross-section, in such a case, the orifice 10 has a form which is complementary to the tubular cross-section of the finger 9. The orifice thus has a circular cross-section.

Alternatively, the cross-section of the finger and the cavity can be square or rectangular, in this last case, a length of the rectangular cross-section is parallel, or substantially parallel, to the longitudinal direction of the end joining piece, it can also be noted that this length could be perpendicular, or substantially perpendicular, to the longitudinal direction of the end joining piece.

In the case when the finger 9 has a square or rectangular cross-section, it then forms a tenon.

The cavity 6 communicates with the receptacle 5 which receives the end pad 28 of the flexible support 3. In other words, the receptacle 5 for the end part 28 of the flexible support 3 and the cavity 6 for receipt of the stud 8 have a common, non-zero volume, this volume corresponding to a space which is common to the receptacle 5 and the cavity 6. Also in other words, a passage exists between the receptacle 5 and the cavity 6, the passage being constituted by an intersection between the receptacle 5 and the cavity 6.

In FIGS. 2 to 5, the stud 8 comprises a central pin 12 which is bordered by two lateral pins 13, 14 provided on both sides of the central pin 12. The central pin 12 has a first thickness E1 which is greater than a second thickness E2 of the lateral pins 13, 14, in particular in order to facilitate grasping of the stud 8 by an operator during the fitting of the wiper 2. In other words, when seen from the front, the stud 8 is arranged in the manner of a podium with three places. The lateral pins 13, 14 each form a shoulder of the central pin 12, for putting it into place inside the cavity 6. The central pin 12 comprises an inner recess 15 which also facilitates grasping of the stud 8 by the operator, by allowing the latter to position a finger inside the inner recess 15, so as to facilitate grasping of the stud 8. The inner recess 15 thus opens out towards the exterior of the stud 8.

In FIGS. 4 to 7, the end joining piece 1 and the flexible support are represented in the final position of use of the wiper 2, in other words in the position of insertion of the end pert 28 of the flexible support 3 inside the receptacle 5 and in the position of assembly of the stud 8 on the flexible joining piece 1.

FIG. 5 is produced according to a first cross-sectional plane Pc1 illustrated in FIG. 4, the first cross-sectional plane Pc1 being parallel to the longitudinal axis A1 and passing through the orifice 10. In FIG. 5, the stud 8 comprises a first face 31 for fitting of the stud 3 on the end joining piece 1 The first fitting face 31 extends from a right-hand lateral pin 13 to a left-hand lateral pin 14, passing via the central pin 12. The first fitting face 31 is flat, and is provided with the finger 9 which extends according to a first direction of extension D₁. The first direction of extension D₁ is in particular orthogonal to a first fitting plane P₁ on which the first fitting face 31 extends. The ringer 9 is preferably provided plumb with the central pin 12, and according to an axis of symmetry of the latter. In other words, the finger 9 is arranged inside a perimeter, the contours of which are those delimited by a rim of the central pin 12. In the position of assembly of the stud 8 on the end joining piece 1, the first fitting face 31 of the stud 8 is in contact with a second fitting face 32 of the end joining piece 1 which is arranged according to a second fitting plane P₂.

The finger 9 comprises a terminal end provided with a means for rendering integral, which for example is in the form of a bulge 18 designed to immobilise the stud 8 on the end joining piece 1 in the final position of use of the wiper 2, and consecutively to immobilise the end joining piece 1 on the flexible support 3. In particular, the bulge 18 is equipped with a notch 19 in order to facilitate compression of the bulge 18 during sliding of the finger 9 inside the orifice 10 when the stud 8 is put into place inside the cavity 6. The stud 8 and the finger 9 are preferably obtained by moulding a single material, which in particular is plastic in order to be easily deformable, such as to form a monolithic assembly in a single piece. In the final position of use of the wiper 2, the bulge 18 is preferably accommodated inside a space 11 which is partly delimited by the upper wall 26a and by the base wall 27.

Alternatively, the means for rendering integral can be in the form of a tongue which is articulated on a tree end of the tenon, when the finger has a square or rectangular cress-section. The tongue is articulated on the tenon by deformation of material of the tenon. In order to prevent the extraction of the stud, the tongue is blocked behind the base wall 27.

An excessive force intended to remove the stud 8 from the cavity 6 can give rise to pulling off of the finger 9 or of the means for rendering integral formed at the end of the finger 9. The locking means are thus designed to break when a traction force is exerted on the stud 8 in order to attempt to extract it from the cavity 6.

FIGS. 6 and 7 are produced according to a second cross-sectional plane Pc2 illustrated in FIG. 4, the first cross-sectional plane Pc2 being perpendicular to the longitudinal axis A1, perpendicular to the first cross-sectional plane Pc1, and passing through the orifice 10. In FIGS. 6 and 7, the stud 8 comprises a first face 41 for anchoring the stud 8 through the flexible support 3. The first anchoring face 41 is a component of the central pin 12. The first anchoring face 41 is flat, and is arranged according to a first anchoring plane P′1. In the final position of use of the wiper 2, the first anchoring face 41 is accommodated inside a first indentation 20 which is provided through the flexible support 3, and is represented as a broken line in FIG. 3. In the position of assembly of the stud 8 on the end joining piece 1, the first anchoring face 41 of the stud 8 is in contact with a second anchoring face 42 of the end joining piece 1 which is arranged according to a second anchoring plane P′2.

According to a first variant illustrated in FIG. 6, the first anchoring plane P′₁ and the first fitting plane P₁ are arranged in the extension of one another in order to form a common plane of the stud 8. The first anchoring plane P′₁ and the first fitting plane P₁ are thus combined according to the first variant.

According to a second variant illustrated in FIG. 7, the first anchoring plane P′₁ and the first fitting plane P₁ are arranged according to two planes disposed at a non-zero distance D from one another. The first anchoring plane P′₁ and the first fitting plane P₁ are thus distinct according to the second variant.

With reference in succession to FIGS. 2 to 7, a method tor assembly of the wiper 2 comprises a plurality of successive steps, including a preliminary step of placing the stud 8 opposite the corresponding cavity 10, a preliminary step of this type being illustrated in FIG. 2.

The method for assembly of the wiper 2 comprises a first step of insertion of the end part 28 of the flexible support 3 in the position in which it is engaged inside the receptacle 5 of the end joining piece 1, a first step of this type being illustrated in FIG. 3.

The method for assembly of the wiper 2 then comprises a third step of introduction of the stud 8 inside the cavity 8, of the finger 9 inside the orifice 10, and of the anchoring face 41 inside the indentation 20, a second step of this type being illustrated in FIGS. 4 to 7.

1. An end joining piece for a wiper of a window of a vehicle, comprising:
at least one flexible support;
a friction blade configured to be applied against the window;
a receptacle for receiving an end part of the flexible support; and
at least one means for locking the end part of the flexible support in the engaged position inside the receptacle comprising at least one orifice which equips the end joining piece, and at least one stud which is equipped with at least one finger.

2. The end joining piece according to claim 1. wherein the finger is accommodated inside the orifice in a position of use of the wiper.

3. The end joining piece according to claim 1, wherein the orifice is arranged inside a base wall which delimits a cavity for receipt of the stud.

4. The end joining piece according to claim 3, wherein the cavity is in communication with the receptacle for receipt of the end part of the flexible support.

5. The end joining piece according to claim 1, wherein the stud comprises a central pin which is bordered by two lateral pins provided on both sides of the central pin.

6. The end joining piece according to claim 5, wherein the central pin has a first thickness greater than a second thickness of at least one of the lateral pins.

7. The end joining piece according to claim 6, wherein the central pin comprises an inner recess.

8. The end joining piece according to claim 5, wherein the finger is arranged plumb with the central pin.

9. The end joining piece according to claim 1, wherein the finger comprises a means for rendering the stud integral on the end joining piece.

10. The end joining piece according to claim 9, wherein the means for rendering integral comprise a terminal end of the finger which is equipped with a bulge provided with at least one notch.

11. A wiper comprising: at least one end joining piece according to claim 1 and the flexible support inserted inside the receptacle.

12. The wiper according to claim 11, wherein the stud comprises a first face for anchoring of the stud inside an indentation in the flexible support, the first anchoring face extending according to a first anchoring plane which is parallel to a first fitting plane.

13. The wiper according to claim 12, wherein the first fitting plane and the first anchoring plane are combined.

14. The wiper according to claim 12, wherein the first fitting plane and the first anchoring plane are distinct.

15. A wiper system comprising: a wiper according to claim 1, and an arm to drive the said wiper.

16. A method for assembly of a wiper according to claim 1, wherein the assembly method comprises:
a first step of insertion of the end part of the flexible support in the position engaged inside the receptacle of the end joining piece.

17. The method for assembly of a wiper according to claim 16, further comprising:
a second step of introduction of the stud inside the cavity, of the finger inside the orifice, and of the second anchoring face inside an indentation arranged in the flexible support.
